(19) United States
(12) Patent Application Publication
(10) Pub. No.: US 2023/0111765 A1
(43) Pub. Date: Apr. 13, 2023

(54) METHOD AND SYSTEM TO AUGMENT VISUAL INSPECTION PROCESS BASED ON ARTIFICIAL INTELLIGENCE TECHNIQUES

(71) Applicant: Panasonic Intellectual Property Management Co., Ltd., Osaka (JP)

(72) Inventors: Zong Sheng Tang, Singapore (SG); Ariel Beck, Singapore (SG); Khai Jun Kek, Singapore (SG); Chandra Suwandi Wijaya, Singapore (SG)

(21) Appl. No.: 17/500,833

(22) Filed: Oct. 13, 2021

(51) Int. Cl. G06K 9/62

(52) U.S. Cl. CPC G06K 9/6264; G06K 9/6259

(57) ABSTRACT

The present subject matter describes a method for labeling data in a computing system based on artificial intelligent techniques. The method comprises receiving input data and ordering the received input-data in a plurality of classes inferred based on at-least one of clustering and anomaly detection. The method further comprises receiving one more manual annotated labels for the ordered data. A first machine-learning (ML) model is trained with respect to the ordered data and thereby generating new labels. The performance of the first ML model is computed based on a comparison between the manual labels and the new labels. The labels are automatically propagated to unlabelled-portion of the ordered data based on execution of the first ML model based on accuracy of first ML model being above a predefined threshold.

### TECHNICAL FIELD

The present-invention generally relates to artificial-intelligence (AI) enabled inspection of processes and in particular, relates to visual-inspection based labelling of images.

### BACKGROUND

State of the art vision-inspection processes are labour-intensive. In particular, labelling of data does take time. Projects with large data-size require data-labelling process stretches through days or even weeks. This potentially increases probability of human-errors that creeps inside a final vision-inspection model.

A prior art publication refers semi-automatic Labeling of Datasets through an AI Tool to annotate data semi-automatically. The publication refers an unlabeled or partially labelled target dataset which is modelled with a machine learning model for classification (or regression). The target dataset is processed by the machine learning model, and a subgroup of the target dataset is prepared for presentation to a user for labelling or label verification; label verification or user re-labelling or user labelling of the subgroup is received, and the updated target dataset is re-processed by the machine learning model. User labelling or label verification combined with modelling an unclassified or partially classified target dataset with a machine learning model aims to provide efficient labelling of an unlabelled-component of the target dataset.

However, the prior art publication necessitates a pre-trained model as input and incur huge time during the course of manual annotation. The prior art mandates employment of supervised machine learning model (input provided with labels) and consumes substantial time during the manual annotation part. Last but not the least, the prior arts does not evaluate performance.

Another prior art publication prescribes a cloud server based application that uses Ground-Truth to label data, wherein the user ‘randomly’ selects images for user for initial-annotation. Yet, such prior art application serve one image at a time for annotation. Such kind of prior-art applications rather suit images with large variance and definitely not factory data that is presented in batches. Moreover, the application requires the client to upload the confidential data to the cloud and thereby compromises confidentiality. Last but not the least, such cloud-based applications require custom configuration and a specialized-knowledge of network engineering.

### SUMMARY

This summary is provided to introduce a selection of concepts in a simplified format that are further described in the detailed description of the present disclosure. This summary is not intended to identify key or essential inventive concepts of the claimed subject matter, nor is it intended for determining the scope of the claimed subject matter. In accordance with the purposes of the disclosure, the present disclosure as embodied and broadly described herein, describes method and system for predicting or classifying condition of any material or object or any feature/attribute related to the material/object either in a fully automated environment or through a semi-automatic mechanism.

A method for labeling data in a computing system based on artificial intelligent techniques. The method comprises receiving input data and ordering the received input-data in a plurality of classes inferred based on at-least one of clustering and anomaly detection. The method further comprises receiving one more manual annotated labels for the ordered data. A first machine-learning (ML) model is trained with respect to the ordered data and thereby generating new labels. The performance of the first ML model is computed based on a comparison between the manual labels and the new labels. The labels are automatically propagated to unlabelled-portion of the ordered data based on execution of the first ML model based on accuracy of first ML model being above a predefined threshold.

The present subject matter refers a Graphical user interface (GUI) to detect anomaly in an environment based on AI techniques. The GUI comprises a first area of display-screen configured to receiving input data to display one or more user-controls for receiving a user selection and thereby enable performance of the various steps such as selecting whether a received input data is labelled or unlabelled, selecting a feature extraction method for the labelled data to enable classification in a plurality of classes, and selecting a clustering and/or anomaly detection for unlabelled data to enable classification in a plurality of classes. A second area of display-screen is configured to display the data arranged into the plurality of classes. A third area of display-screen is configured to display a plurality of controls for receiving a user selection for: receiving one more user manual annotated labels for the data arranged into the plurality of classes, training a first machine-learning (ML) model with respect to the ordered data and thereby generating new labels, trigger display of comparison between the user annotated labels and the new labels, and propagate labels to unlabelled portion of the ordered data based on execution of the first ML model subject.

The objects and advantages of the embodiments will be realized and achieved at-least by the elements, features, and combinations particularly pointed out in the claims. It is to be understood that both the foregoing general description and the following detailed description are representative and explanatory and are not restrictive of the invention, as claimed.

### BRIEF DESCRIPTION OF THE DRAWINGS

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

FIG. 1 illustrates method steps in accordance with the embodiment of the present subject matter;

FIG. 2 illustrates method steps in accordance with another embodiment of the present subject matter;

FIG. 3 illustrates an example method in accordance with the FIG. 1 to speed up labelling process in accordance with an embodiment of the present subject matter;

FIGS. 4a and 4b illustrate a model in accordance with the description of FIG. 1 and FIG. 2, in accordance with an embodiment of the present subject matter;

FIG. 5 illustrates a GUI referring an initialization-phase, in accordance with an embodiment of the present subject matter;

FIG. 6 illustrates a GUI or a first area of the display of the GUI while referring the FIGS. 4a and 4b in accordance with an embodiment of the present subject matter;

FIG. 7 illustrates a GUI or a first area of the display of the GUI while referring FIGS. 4a and 4b, in accordance with an embodiment of the present subject matter;

FIG. 8 illustrates a GUI referring the data associated with the image folder in accordance with an embodiment of the present subject matter;

FIGS. 9a and 9b illustrate a GUI referring the data associated with the image folder in accordance with an embodiment of the present subject matter;

FIG. 10 refers a description corresponding to FIGS. 4a and 4b in accordance with an embodiment of the present subject matter;

FIG. 11 illustrates a GUI having controls to operate over the ordered data in accordance with an embodiment of the present subject matter;

FIG. 12 illustrates a GUI having controls to operate over the ordered data in accordance with an embodiment of the present subject matter;

FIGS. 13a and 13b illustrate the GUI to refer one or more controls for accuracy testing and propagation of labels in accordance with an embodiment of the present subject matter;

FIG. 14 refers a GUI to identify the labels which are deemed suspicious accordance with an embodiment of the present subject matter; and

FIG. 15 illustrates an implementation of the system as illustrated in preceding figures in a computing environment, in accordance with another embodiment of the present subject matter.

The elements in the drawings are illustrated for simplicity and may not have been necessarily been drawn to scale. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present subject matter are described below in detail with reference to the accompanying drawings.

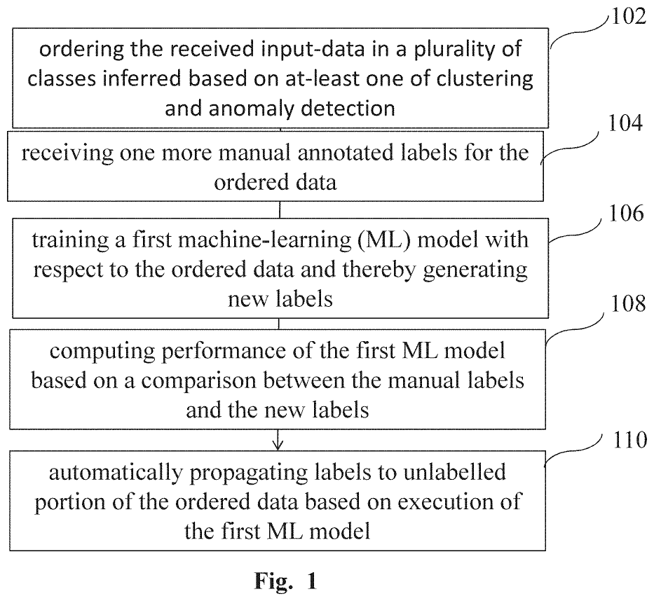

FIG. 1 illustrates method steps in accordance with an embodiment of the present subject matter.

The present subject matter refers a method for labelling data in a computing system based on artificial intelligent techniques. The method comprises receiving (step 102) input data and ordering (step 102) the received input-data in a plurality of classes inferred based on at-least one of clustering and anomaly detection.

In case the received input data corresponds to a partially-labelled data, then ordering the data into a plurality of classes is based on training an initial machine learning model based on partial-labels of the received input data. The received input is ordered into the plurality of classes inferred based on execution of the initial machine-learning model that is trained on the partial labels.

In case the received input data corresponds to an unlabelled data comprising an imbalance of categories, then the ordering the data into a plurality of classes is based on anomaly detection or clustering. The ordering of the unlabelled data comprises arranging the unlabelled data in at least one of a normalized and/or aligned manner, such alignment optionally being based on at-least one of data normalization and data-alignment method. The arranged unlabelled data is split into one or more classes based on at-least one of the clustering and the anomaly-detection.

As may be understood from aforesaid, prior to said ordering of the input data, the method steps comprises ascertaining presence or absence of existing labels within the input data. At least one of normalization and data alignment is performed for ordering the data based on processes defined by one or more of: a first method based on ascertaining the presence of existing labels, and a second method based on ascertaining the absence of existing labels. The first method relates to a supervised machine learning based on feature extraction and corresponds to the steps of normalizing or aligning the data, generating an initial machine learning model upon ascertaining the presence of labels, and training the initial machine learning model based on the labels.

The second method relates to unsupervised machine learning based on a clustering method. The same corresponds to the steps of normalizing or aligning the data, and performing at least one of the clustering and anomaly detection upon the normalized and aligned data to generate clusters. The outcome of each of the first and the second method as employed comprises ordering of the input data comprises displaying standard quality (OK) class images and sub-standard quality (NG) class images alternately.

The method further comprises receiving (step 104) one more manual-annotated labels for the ordered data. The manual user-annotation comprises arranging the received input data based on the plurality of classes, displaying the arranged data over a user interface, and thereafter receiving a manual label from the user directed to each class of the plurality of classes of arranged data to thereby enable a speedy manual-annotation of the received input data.

The method further comprises training (step 106) a first machine-learning (ML) model with respect to the ordered data and thereby generate new-labels and computing (step 108) performance of the first ML model based on a comparison between the manual labels and the new labels. Based on accuracy of first ML model being above a predefined threshold, the labels are automatically propagated (step 110) to unlabelled portion of the ordered data based on execution of the first ML model.

In case of the accuracy being below the threshold, the method further comprises communicating the ordered-data with labels associated with the portion of the ordered data to the initial machine-learning model. The data is normalized or aligned based on re-execution of the initial machine learning model for resulting into re-ordered data. The re-ordered data is iteratively communicated for re-annotation of labels by the user to thereby re-compute (step 108) accuracy of the first ML model based on the re-annotated labels acting as ground truth. Thereafter, the control flow again proceeds to step 110 onwards.

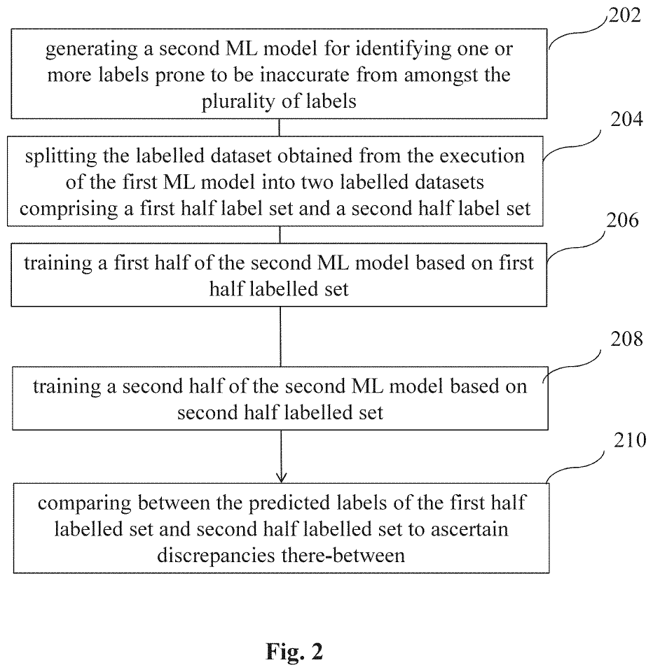

FIG. 2 illustrates method steps in accordance with an embodiment of the present subject matter.

The method further comprises generating (step 202) a second ML model for identifying one or more labels prone to be inaccurate from amongst the plurality of labels generated by the first ML model for at least the remaining portion of the ordered data. The generation comprises splitting (step 204) the labelled dataset obtained from the execution of the first ML model into two labelled datasets comprising a first half label set and a second half label set.

A first half of the second ML model is trained (step 206) based on first half labelled set and the trained first half of the second ML model is executed to predict labels of the second half labelled set. A second half of the second ML model is trained (step 208) based on second half labelled set. The trained second half of the second ML model is executed to predict labels of the first half labelled set.

A comparison is drawn (step 210) between the predicted labels of the first half labelled set and second half labelled set to ascertain discrepancies there-between and thereby ascertain one or more suspicious labels as predicted.

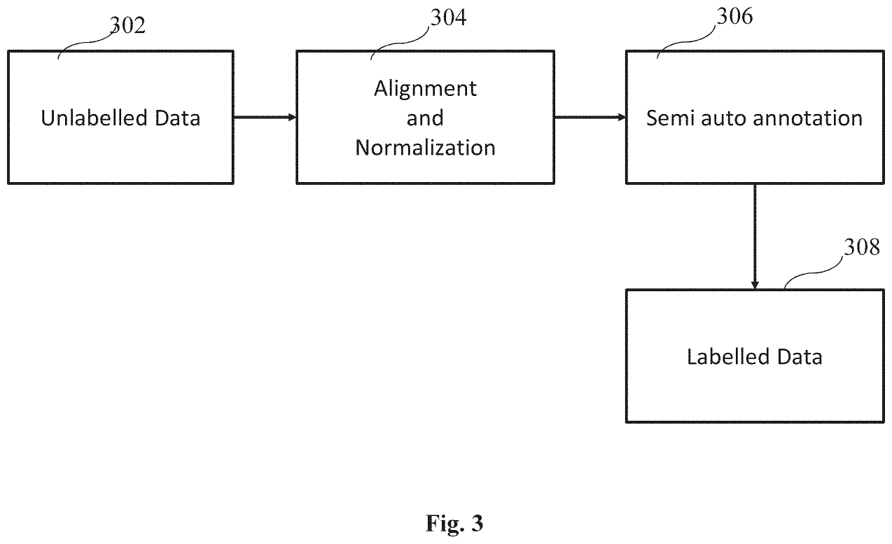

FIG. 3 illustrates an example method in accordance with the FIG. 1 to speed up labelling process by utilising the machine learning process. Depending on the availability of partial label, the present subject matter refers a method to allow propagation model prediction to unlabelled data. A Graphical user interface (GUI) element allows operator to speed up labelling-process by serving files in batches compare to single file annotation.

Step 302 refers the example raw-images received from a factory-line and corresponds to step 102.

Step 304 refers normalization of all images that are placed likewise and corresponds to step 102. More specifically, all image samples are positioned in a same way. In an example, the normalization defines equalization of the brightness across the full-dataset.

Step 306 refers a tool in accordance with the steps 104, 106 and 108 to speed up annotation process.

Step 308 refers that labels are automatically propagated to all images and corresponds to step 110. The labels are used for Machine-learning ML training in accordance with the method steps 202 till 210 provided with respect to FIG. 2.

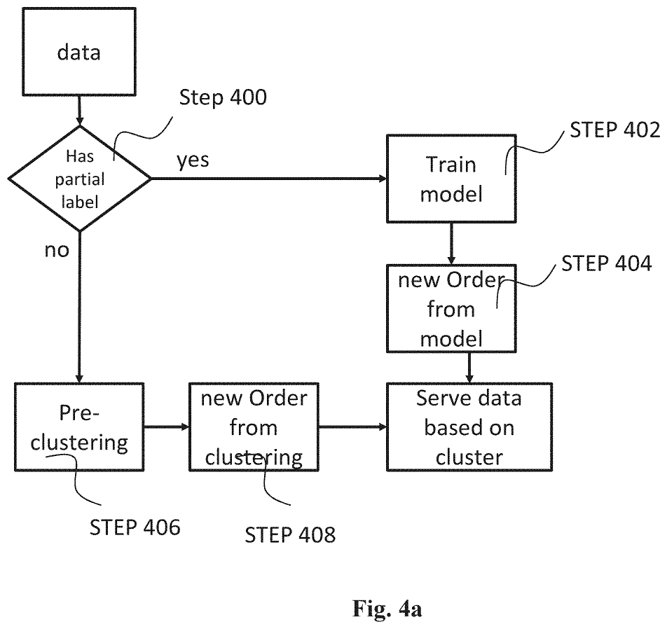

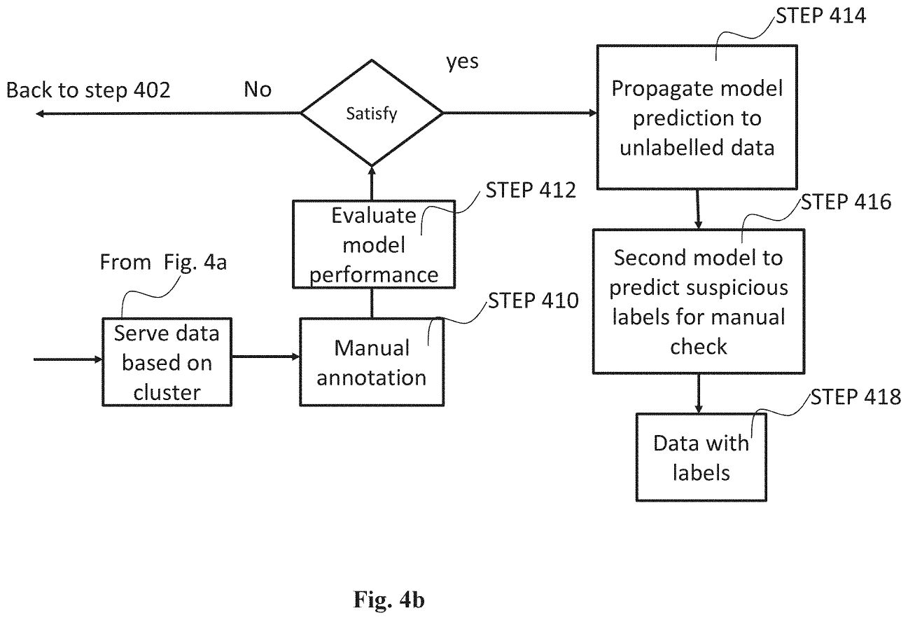

FIGS. 4a and 4b illustrate a model in accordance with the description of FIG. 1 and FIG. 2 which is capable to operate with or without pre-existing labels. As a precursor, it may be ascertained (as depicted through decision box 400), whether the data has partial labels or no labels.

At step 402, when there is partial label case, a machine learning model is trained with the partial labels in accordance with the step 102.

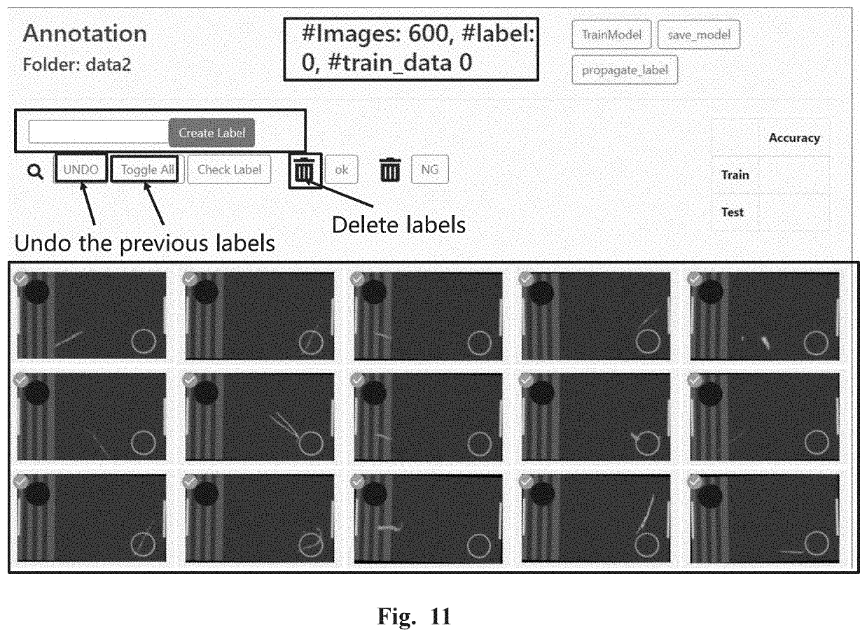

At step 404, the model rearranges and serves the unlabelled data in a structured order as depicted in FIG. 11 compare to random order. The present step corresponds to step 102.

At step 406, in the case of starting without pre-existing labels, the order of the data or the file order is triggered to be predicted based on pre-clustering or anomaly detection in accordance with the step 102.

At the step 408, the order is predicted by an unsupervised model (pre-clustering or anomaly detection) in accordance with step 102.

At step 410, manual annotation is performed in accordance with step 104.

At step 412, the subsequence manual labels of step 410 serve as the metric to evaluate a trained ML model in accordance with steps 106 and 108.

At step 414, once the model shows a satisfactory evaluation, the model propagates the prediction or labels to the rest of the unlabelled data in accordance with step 110.

At step 416, after the labels have been to all the data, a second ML model is trained in accordance with the method steps 202 to 208.

At step 418, the suspicious labels are predicted in accordance with step 210. Such suspicious labels are flagged for manual confirmation by the user.

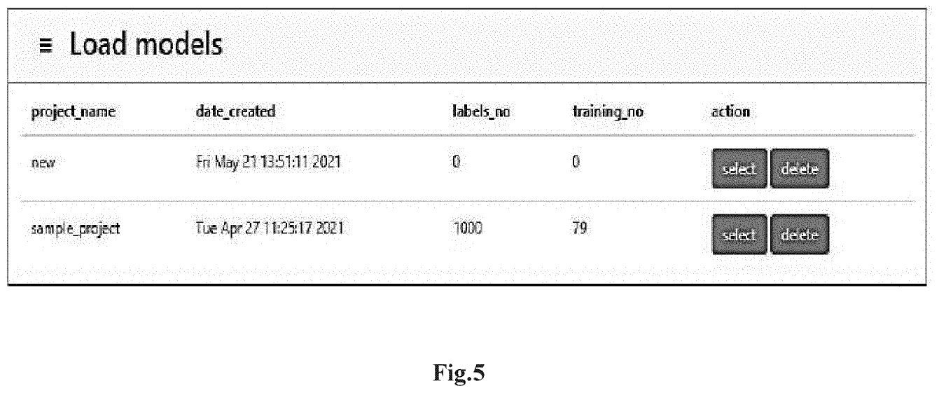

FIG. 5 illustrates a GUI referring an initialization-phase as a part of first area of the display of the GUI, wherein an existing project (already saved state) may be loaded to resume such saved project. The present figure refers an optional state.

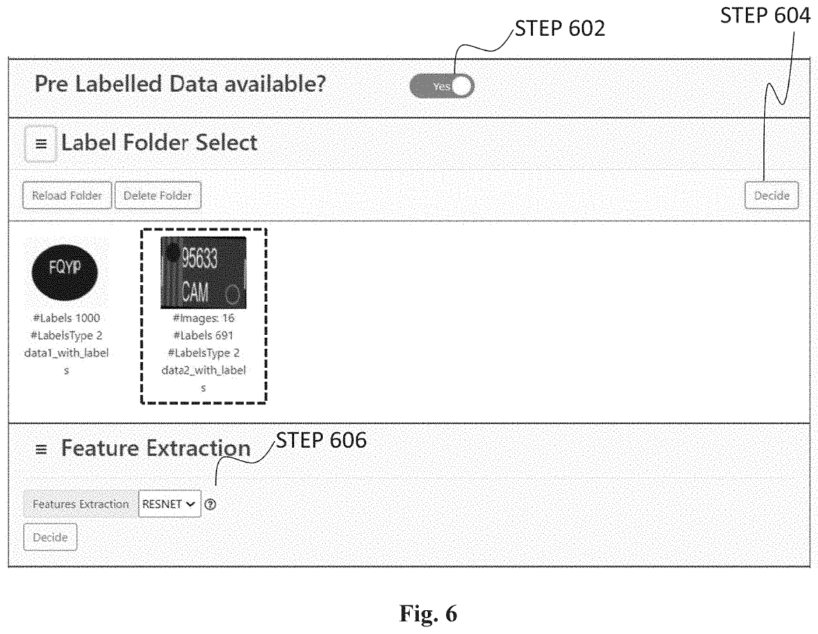

FIG. 6 illustrates a GUI or a first area of the display of the GUI while referring the step 402 of FIGS. 4a and 4b. The GUI in present figure refers to labelled input data processing and a supervised machine-learning. Following are the steps of operation with respect to the present GUI.

At step 602, a control button is toggled to “yes” if there is an existing label.

At step 604, a desired image folder is selected.

At step 606, a feature extraction method (e.g. RESNET) is selected.

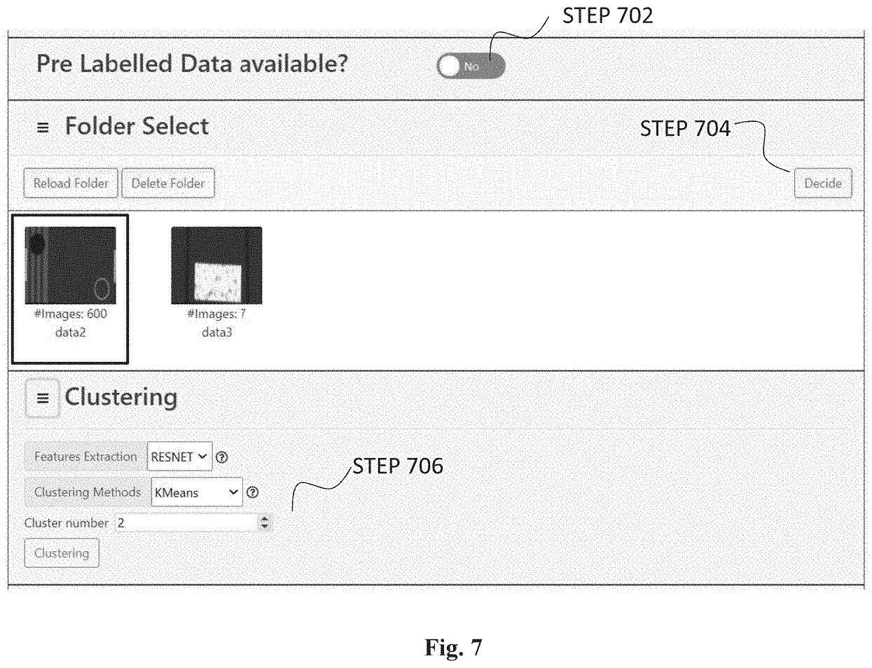

FIG. 7 illustrates a GUI or a first area of the display of the GUI while referring the step 406 of FIGS. 4a and 4b, and thereby refers to unlabelled input data processing and an unsupervised machine learning. Following are the steps of operation with respect to the GUI

At step 702, a control button is toggled to “NO” if there is no existing label.

At step 704, a desired image-folder is selected.

At step 706, a feature-extraction method (e.g. Resnet) and a clustering method (e.g. K means clustering) is selected.

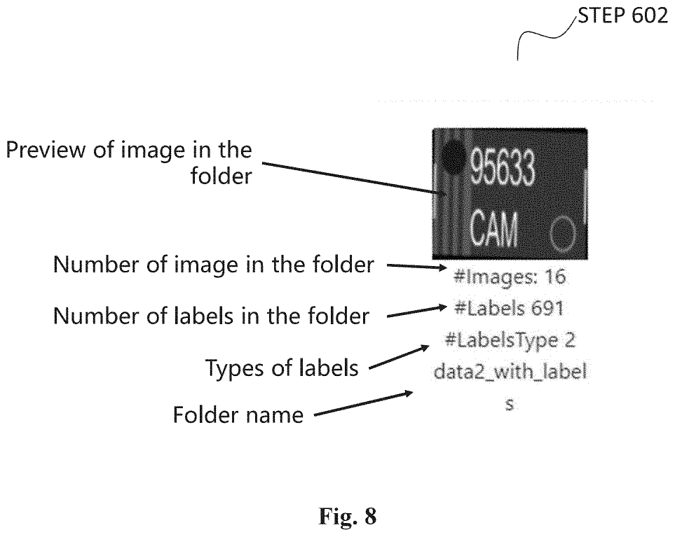

FIG. 8 illustrates a GUI referring the data associated with the image folder in case of labelled data of step 402 and step 602. The image folder provides preview of image in the folder, number of images in the folder, number of labels in the folder, types of labels and folder name.

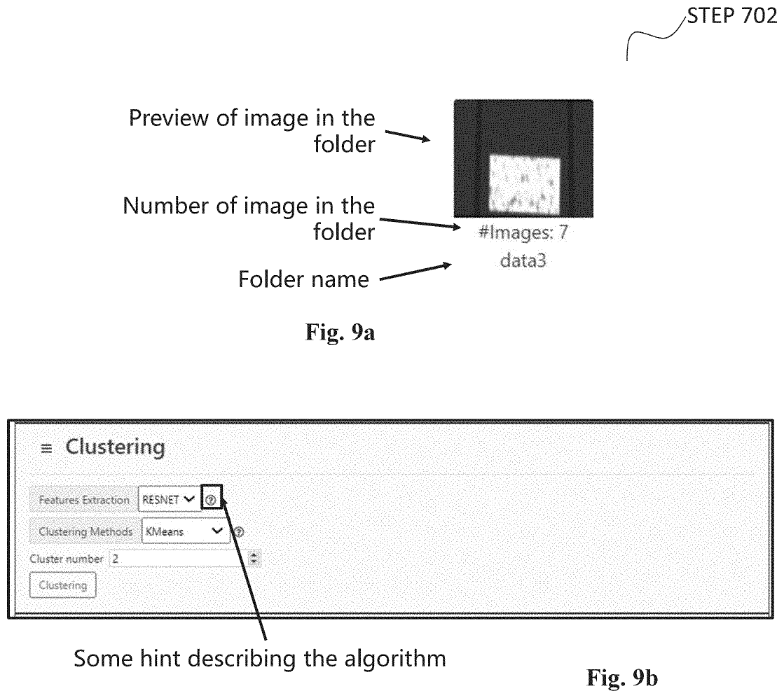

FIGS. 9a and 9b illustrate a GUI referring the data associated with the image folder in case of unlabelled data of step 406 and corresponds to step 702. As referred in FIG. 9a, the image folder provides preview of image in the folder, number of images in the folder, and folder name. As referred in FIG. 9b, a control button is provided to select one or more feature extraction methods, clustering methods and anomaly detection methods.

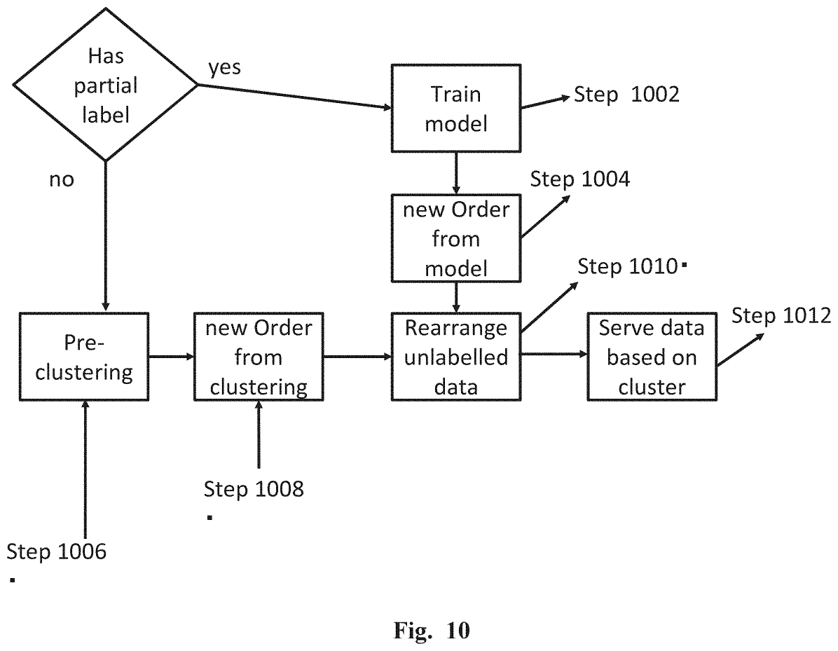

FIG. 10 refers a description corresponding to FIGS. 4a and 4b, and accordingly elaborates the order of data.

Step 1002 corresponds to step 402 and refers training of model based on the partial label.

Step 1004 corresponds to step 404 and refers generation of new order based on the model generated at Step 1002.

Step 1006 corresponds to step 406 and refers clustering of data based on the settings decided by the user as provided within the description of FIGS. 9a and 9b.

Step 1008 corresponds to step 408 and refers generation of new order based on the result of Step 1008.

Step 1010 refers rearrangement of unlabelled data based on the order of step 1008 or the step 1004.

Step 1012 refers serving of data in clusters or classes based on the rearrangement in step 1010.

FIG. 11 illustrates a GUI and specifically refers a second area of the display within the GUI having controls to operate over the ordered data as served from the step 1012. More specifically, the received input data is arranged based on the plurality of classes and accordingly displayed over a user-interface. As referred in previous figures, the M.L or clustering based grouping as employed to group and present images into OK and NG classes significantly boosts the annotation speed.

As indicated in the FIG. 11, ordered data with respect to example number of 600 images has been shown and represented by a data field “#images”. Since the manual annotation is yet to happen, the number of labels (represented by the data-field “#label”) have been shown to be 0 or NULL. Another data field “#train_data” refers the number of training images as used. Further, the GUI comprises various controls for undoing or deleting previous labels (e.g. Ok or Not Good ‘NG’ based labels) attached to the ordered data.

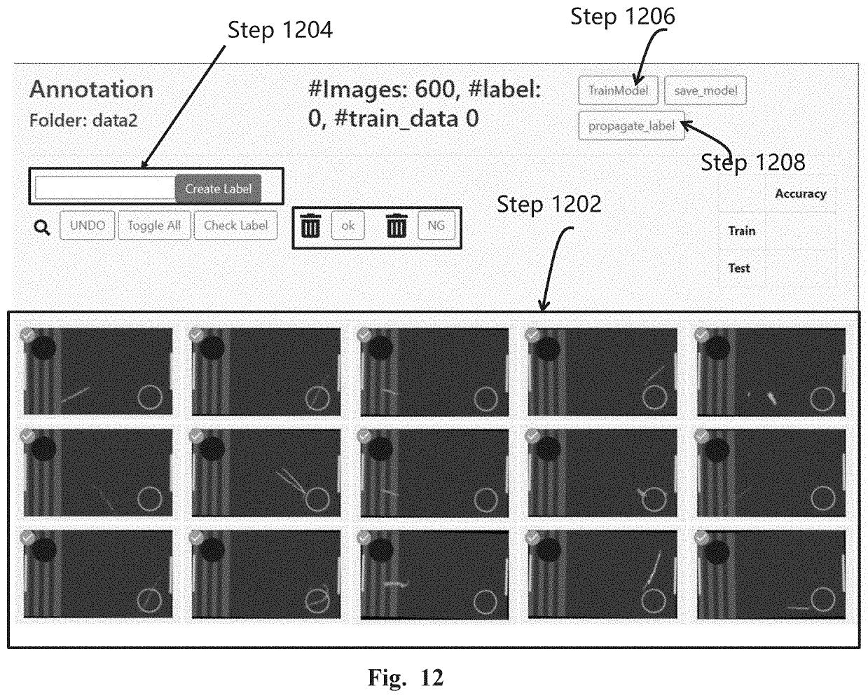

FIG. 12 illustrates a GUI and specifically refers a third area of the display of the GUI that comprises controls to operate over the ordered data. Such controls are provided for purposes of manual-annotation in accordance with step 104 of FIG. 1 and step 410 of FIGS. 4a and 4b. More specifically, with respect to step 410, the GUI comprises controls for performing the following steps:

Step 1202: Toggle data to be labelled. Such a “toggle-all” based action from the user at the user interface simultaneously annotates entire displayed data with respect to a particular class. Specifically, toggle all button can be used to label in group after a few iterations and especially when majority of the images grouped into the particular-class are actually in compliance. For example, when 80-90 percent of the images in Ok class actually appear to be OK, toggle all may be used to annotate all images in OK class as OK

Step 1204: New labels are created for the images in ordered data. Optionally, and if required, a further action from the user with respect to the arranged data as annotated by the “toggle all” based action may be executed. Such further action is directed to change at least one individual annotation from the particular-class to a different-class. For example, an image or two or say 5-10 percent images in the OK class may be rather NG and accordingly erroneous However, the usage of toggle all button may have annotated even such erroneous images also as OK, thereby leading to conflict. In such a scenario, the user may click upon the NG images individually and undo or delete their label. A new label may be created to change the OK label to NG.

To put it differently, if user is labelling a group of OK with one NG in the middle, the user first presses toggle all, and then clicks upon the NG error. Accordingly for error correction, merely one or two or at best a handful of clicks are needed to label all the images and the corrected image, because all images grouped as OK/NG are presented adjacent to each other.

Step 1205: The labels as made vide said toggle all option in step 1202 and individual annotation in the previous step 1204 may be saved via control “Check label”.

As may be understood, the user alternates or toggles between OK and NG images within the GUI which considerably speeds up the manual labelling or manual annotation.

As a result due to annotation, for example, 7 labels may be created or 7 images may be labelled. Accordingly, the data-fields as provided in the description of FIG. 11 and forming a part of the GUI undergo change in data values defined in following Table 1

| | |
|---|---|
| #images: 593 | Value decreased by 7 |
| # labels: 7 | Values increased by 7 |
| # train_data: | Values unchanged |

Further, when sufficient labels have been generated (for example more than 50 images have been labelled manually), then a first ML may be trained based on the step 106 and as a part of step 410. A designated control defined by step 1206 is provided for such purposes to train the model. Once the first ML model is trained, then the first ML model provides predicted labels or new labels for the ordered data that may be compared with the manual labels annotated by the user to compute accuracy as depicted in the forthcoming figure.

Overall, the GUI as depicted in FIG. 12 corresponds to third area of display screen which comprises a “toggle-all” control to simultaneously annotate entire displayed data with respect to a particular class, an “undo-all” control to simultaneously reverse annotation of entire displayed data, at least one control to individually annotate arranged data with respect to a particular class, at least one control to modify annotation with respect to the arranged data; and at least one control to delete an annotation with respect to the arranged data.

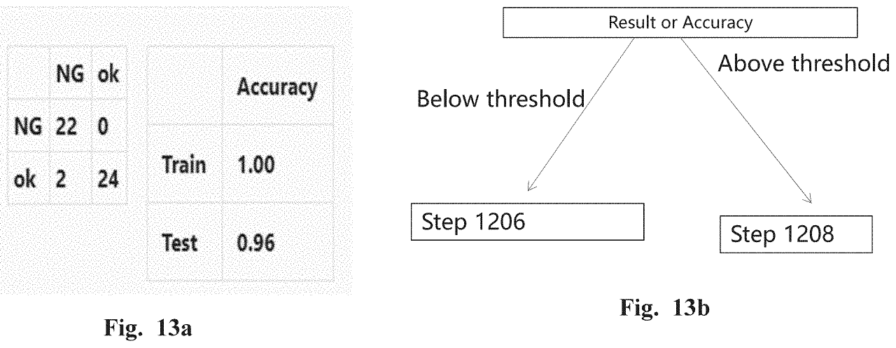

FIGS. 13a and 13b illustrate the GUI and more specifically refers the third area of the display of the GUI to refer one or more controls to perform the steps 412 and steps 414 of FIGS. 4a and 4b. More specifically, the present description of FIGS. 13a and 13b corresponds to computation of performance with respect to the step 110 of FIG. 1.

FIG. 13a refers computation of accuracy with respect to predicted new labels from the trained first ML as referred in FIG. 12. The test accuracy for 48 new labels (example) predicted from the first ML model is computed based on comparison with 48 manually annotated (ground truth) labels as follows:

(22+24)/(22+24+2)=0.96

As may be observed from example of FIG. 13a, two OK based labels are miscomputed as NG labels and accordingly the efficiency is computed as 0.96. Since the efficiency as computed may be on higher side or complies with a predefined threshold, step 110 or step 414 holds valid. Accordingly in such a scenario, FIG. 13b refers resorting to step 1208 (of FIG. 12) by the user to propagate the labels to the unlabelled data in accordance with the step 110.

However, in case of the computed test accuracy falling below threshold, the user can continue labelling & train model again vide step 1206 of FIG. 12.

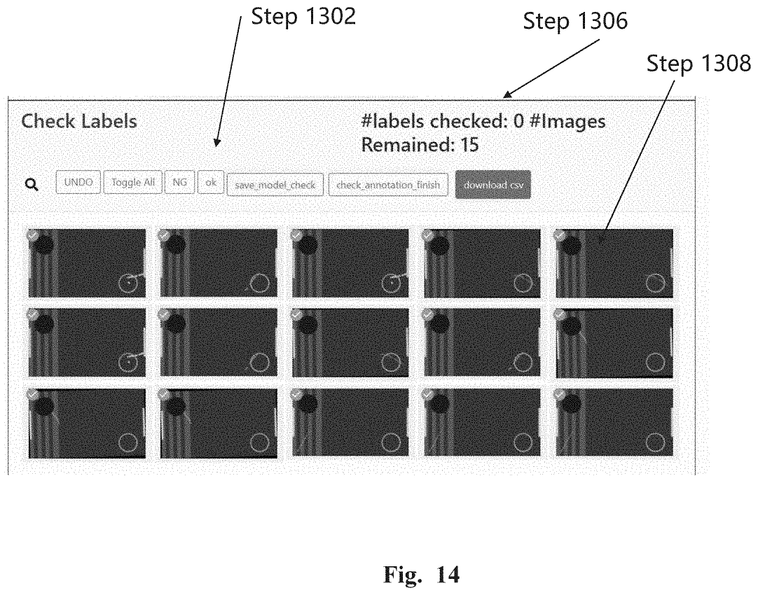

FIG. 14 refers a GUI and more specifically a fourth area within the display of the GUI to provide or more controls to examine some labels (propagated labels of step 110 and 414) and thereby identify the labels which are deemed suspicious in accordance with the steps 202 to 210 of FIG. 2 and steps 416 of FIGS. 4a and 4b. Upon processing through the second ML model as referred in the description of FIG. 2, the suspicious labels are ascertained or identified as doubtful labels in accordance with step 418. In other words, the second ML model identifies the discrepancy in the prediction by the first ML models and sends such anomalous labels for reconsideration by the user. The steps of operation with respect to FIG. 14 are as follows:

At step 1302, the labels from the previous steps, i.e. propagated labels from step 110 and step 412 are loaded.

At step 1304, a counter recurrently executes to depict the images left for processing to ascertain the suspicious labels.

At step 1306, the suspicious labels are served in accordance with the step 210 and 418 for manual check by the user.

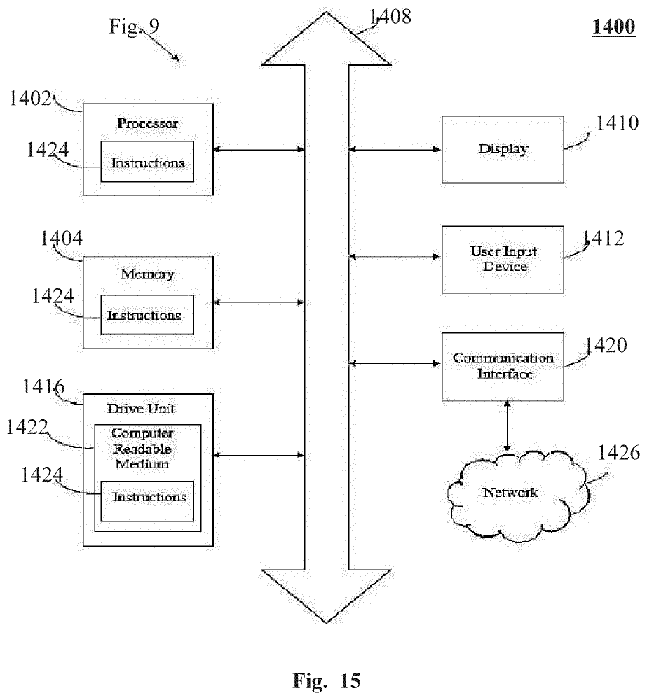

FIG. 15 illustrates an implementation of the system as illustrated in FIG. 1 till 14 in a computing environment. The present figure essentially illustrates the hardware configuration of the system. The computer system 1400 can include a set of instructions that can be executed to cause the computer system 1400 to perform any one or more of the methods disclosed. The computer system 1400 may operate as a standalone device or may be connected, e.g., using a network, to other computer-systems or peripheral devices.

In a networked deployment, the computer system 1400 may operate in the capacity of a server or as a client user computer in a server-client user network environment, or as a peer computer system in a peer-to-peer (or distributed) network environment. The computer system 1400 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 1400 is illustrated, the term “system” shall also be taken to include any collection of systems or sub-systems that individually or jointly execute a set, or multiple sets, of instructions to perform one or more computer functions.

The computer system 1400 may include a processor 1402 (e.g., a central processing unit (CPU), a graphics processing unit (GPU), or both. The processor 1402 may be a component in a variety of systems. For example, the processor 1402 may be part of a standard personal computer or a workstation. The processor 1402 may be one or more general processors, digital signal processors, application specific integrated circuits, field programmable gate arrays, servers, networks, digital circuits, analog circuits, combinations thereof, or other now known or later developed devices for analyzing and processing data The processor 1402 may implement a software program, such as code generated manually (i.e., programmed).

The computer system 1400 may include a memory 1404, such as a memory 1404 that can communicate via a bus 1408. The memory 1404 may be a main memory, a static memory, or a dynamic memory. The memory 1404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1404 includes a cache or random access memory for the processor 1402. In alternative examples, the memory 1404 is separate from the processor 1402, such as a cache memory of a processor, the system memory, or other memory. The memory 1404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1404 is operable to store instructions executable by the processor 1402. The functions, acts or tasks illustrated in the figures or described may be performed by the programmed processor 1402 executing the instructions stored in the memory 1404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1400 may or may not further include a display unit 1410, such as a liquid crystal display (LCD), an organic light emitting diode (OLED), a flat panel display, a solid state display, a cathode ray tube (CRT), a projector, a printer or other now known or later developed display device for outputting determined information. The display 1410 may act as an interface for the user to see the functioning of the processor 1402, or specifically as an interface with the software stored in the memory 1404 or in the drive unit 1416.

Additionally, the computer system 1400 may include an input device 1412 configured to allow a user to interact with any of the components of system 1400. The input device 1412 may be a number pad, a keyboard, or a cursor control device, such as a mouse, or a joystick, touch screen display, remote control or any other device operative to interact with the computer system 1400.

The computer system 1400 may also include a disk or optical drive unit 1416. The disk drive unit 1416 may include a computer-readable medium 1422 in which one or more sets of instructions 1424, e.g. software, can be embedded. Further, the instructions 1424 may embody one or more of the methods or logic as described. In a particular example, the instructions 1424 may reside completely, or at least partially, within the memory 1404 or within the processor 1402 during execution by the computer system 1400. The memory 1404 and the processor 1402 also may include computer-readable media as discussed above.

The present invention contemplates a computer-readable medium that includes instructions 1424 or receives and executes instructions 1424 responsive to a propagated signal so that a device connected to a network 1426 can communicate voice, video, audio, images or any other data over the network 1426. Further, the instructions 1424 may be transmitted or received over the network 1426 via a communication port or interface 1420 or using a bus 1408. The communication port or interface 1420 may be a part of the processor 1402 or may be a separate component. The communication port 1420 may be created in software or may be a physical connection in hardware. The communication port 1420 may be configured to connect with a network 1426, external media, the display 1410, or any other components in system 1400 or combinations thereof. The connection with the network 1426 may be a physical connection, such as a wired Ethernet connection or may be established wirelessly as discussed later. Likewise, the additional connections with other components of the system 1400 may be physical connections or may be established wirelessly. The network 1426 may alternatively be directly connected to the bus 1408.

The network 1426 may include wired networks, wireless networks, Ethernet AVB networks, or combinations thereof. The wireless network may be a cellular telephone network, an 802.11, 802.16, 802.20, 802.1Q or WiMax network. Further, the network 1426 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the system 1400.

At least based on aforesaid, the present subject matter provides the U.I elements that allow an operator to speed up labelling process using ML model and leverage with fraction of manual labels. The preculstering and trained model rearranges the files that are served to the users according to cluster, thereby helping the operator to check images in batch. Further, the final label check is done to check the propagated labels that are deemed suspicious by the ML model.

Pre clustering allows to serve the unlabelled data according to clusters, and thereby the images are served in batches and exhibit more suitability with factory data. The present subject matter's tool executes in local environment and does not need extra configurations, thereby being suitable for factory technician.

Terms used in this disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms or both terms. For example, the phrase “A or B” should be understood to include the possibilities of “A” or “B” or “A and B.”

All examples and conditional language recited in this disclosure are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that various changes, substitutions, and alterations could be made thereto without departing from the spirit and scope of the present disclosure.

1. A method for labeling data in a computing system based on artificial intelligent techniques, said method comprising:
receiving input data;
ordering the received input-data in a plurality of classes inferred based on at-least one of clustering and anomaly detection;
receiving one more manual annotated labels for the ordered data;
training a first machine-learning (ML) model with respect to the ordered data and thereby generating new labels;
computing performance of the first ML model based on a comparison between the manual labels and the new labels; and
automatically propagating labels to unlabelled portion of the ordered data based on execution of the first ML model based on accuracy of first ML model being above a predefined threshold.

2. The method as claimed in claim 1, wherein in case the received input data corresponds to a partially labelled data, then ordering the data into a plurality of classes is based on:
training an initial machine learning model based on partial labels of the received input data; and
ordering the received input into the plurality of classes inferred based on execution of the initial machine learning model that is trained on the partial labels.

3. The method as claimed in claim 1, wherein in case the received input data corresponds to an unlabelled data comprising an imbalance of categories, the ordering comprising:
ordering the data into a plurality of classes based on anomaly detection

4. The method as claimed in claim 1, wherein the manual annotation comprises:
arranging the received input data arranged based on the plurality of classes;
displaying the arranged data over a user interface; and
receiving a manual label from the user directed to each class of the plurality of classes of arranged data to thereby enable a speedy manual annotation of the received input data.

5. The method as claimed in claim 1, further comprising generating a second ML model for identifying one or more labels prone to be inaccurate from amongst the plurality of labels generated by the first ML model for at least the remaining portion of the ordered data, said generation comprising:
splitting the labelled dataset obtained from the execution of the first ML model into two labelled datasets comprising a first half label set and a second half label set;
training a first half of the second ML model based on first half labelled set and executing the trained first half of the second ML model to predict labels of the second half labelled set;
training a second half of the second ML model based on second half labelled set and executing the trained second half of the second ML model to predict labels of the first half labelled set; and
comparing between the predicted labels of the first half labelled set and second half labelled set to ascertain discrepancies there-between and thereby ascertain one or more suspicious labels.

6. The method as claimed in claim 1, wherein the ordering the unlabelled data comprises:
arranging the unlabelled data in at least one of a normalized and/or aligned manner, said alignment optionally based on at-least one of data normalization and data-alignment method; and
splitting the arranged unlabelled data into one or more classes based on at least one of the clustering and the anomaly detection.

7. The method as claimed in claim 1, wherein prior to said ordering of the input data, the method further comprises:
ascertaining presence or absence of existing labels within the input data;
performing at least one of normalization and data alignment for ordering the data based on processes defined by one or more of:
a first method based on ascertaining the presence of existing labels; and
a second method based on ascertaining the absence of existing labels.

8. The method as claimed in claim 7, wherein the first method relates to a supervised machine learning based on feature extraction and corresponds to the steps of:
normalizing or aligning the data;
generating an initial machine learning model upon ascertaining the presence of labels; and
training the initial machine learning model based on the labels.

9. The method as claimed in claim 7, wherein the second method relates to unsupervised machine learning based on a clustering method corresponds to the steps of:
normalizing or aligning the data; and
performing at least one of the clustering and anomaly detection upon the normalized and aligned data to generate clusters.

10. The method as claimed in claim 1, wherein the ordering the input data further comprises displaying standard quality (OK) class images and sub-standard quality (NG) class images alternately.

11. The method as claimed in claim 8, wherein in case of the accuracy being below the threshold, the method further comprising:
communicating the ordered data with labels associated with the portion of the ordered data to the initial machine learning model;
normalizing or aligning the data based on re-execution of the initial machine learning model for resulting into re-ordered data; and
communicating the re-ordered data for re-annotation of labels by the user to thereby re-compute accuracy of the first ML model based on the re-annotated labels acting as ground truth.

12. A Graphical user interface (GUI) to detect anomaly in an environment based on AI techniques, said GUI comprising:
a first area of display-screen configured to receiving input data to display one or more user-controls for receiving a user selection and thereby enable performance of the steps of:
selecting whether a received input data is labelled or unlabelled;
selecting a feature extraction method for the labelled data to enable classification in a plurality of classes; and
selecting a clustering and/or anomaly detection for unlabelled data to enable classification in a plurality of classes;
a second area of display-screen configured to display the data arranged into the plurality of classes; and
a third area of display-screen configured to display a plurality of controls for receiving a user selection for:
receiving one more user manual annotated labels for the data arranged into the plurality of classes;
training a first machine-learning (ML) model with respect to the ordered data and thereby generating new labels
trigger display of comparison between the user annotated labels and the new labels;
propagate labels to unlabelled portion of the ordered data based on execution of the first ML model subject.

13. The Graphical user interface (GUI) as claimed in claim 12, further comprising a fourth area of display-screen configured to display a plurality of controls for generating a second ML model for identifying one or more labels prone to be inaccurate from amongst the plurality of labels generated by the first ML model for the ordered data.

14. The GUI as claimed in claim 12, wherein the manual annotation comprises:
receiving a manual label from the user directed to each class of the plurality of classes of arranged data to thereby enable a speedy manual annotation of the received input data.

15. The GUI as claimed in claim 12, wherein displaying the plurality of classes comprises:
arranging the unlabelled data in at least one of a normalized and/or aligned manner, said alignment optionally based on at-least one of data normalization and data-alignment method;
splitting the arranged unlabelled data into one or more classes based on at least one of the clustering and the anomaly detection

16. The GUI as claimed in claim 12, wherein displaying the plurality of classes comprises:
normalizing or aligning labelled data based on execution of the initial machine learning model;
generating an initial machine learning model; and
training the initial machine learning model based on the labels associated with the normalized and aligned data.

17. The method as claimed in claim 1, wherein the manual user annotation comprises:
arranging the received input data based on the plurality of classes;
displaying the arranged data over a user-interface;
receiving a “toggle-all” based action from the user at the user interface to simultaneously annotate entire displayed data with respect to a particular class; and
optionally receiving a further action from the user with respect to the arranged data as annotated by the “toggle all” based action, said further action directed to change at least one individual annotation from the particular-class to a different-class.

18. The GUI as claimed in claim 1, wherein the third area of display-screen further comprises at least one of:
a “toggle-all” control to simultaneously annotate entire displayed data with respect to a particular class;
an “undo-all” control to simultaneously reverse annotation of entire displayed data;
at least one control to individually annotate arranged data with respect to a particular class;
at least one control to modify annotation with respect to the arranged data; and
at least one control to delete an annotation with respect to the arranged data.

19. A system for labeling data in a computing system based on artificial intelligent techniques, said system comprising a processor and memory configured for:
receiving input data;
ordering the received input-data in a plurality of classes inferred based on at-least one of clustering and anomaly detection;
receiving one more manual annotated labels for the ordered data through a GUI;
training a first machine-learning (ML) model with respect to the ordered data and thereby generating new labels;
computing performance of the first ML model based on a comparison between the manual labels and the new labels; and
automatically propagating labels to unlabelled portion of the ordered data based on execution of the first ML model based on accuracy of first ML model being above a predefined threshold.

20. The system as claimed in claim 19, wherein in case the received input data corresponds to a partially labelled data, then ordering the data into a plurality of classes is based on:
training an initial machine learning model based on partial labels of the received input data; and
ordering the received input into the plurality of classes inferred based on execution of the initial machine learning model that is trained on the partial labels.
